(19) United States
(12) Patent Application Publication
(10) Pub. No.: US 2012/0178112 A1
(43) Pub. Date: Jul. 12, 2012

(54) METHOD OF DETECTING SKELETAL MUSCLE DAMAGE

(75) Inventors: Julie Christine Barnes, Cambridge (GB); Paul Michael Bradley, Cambridge (GB)

(73) Assignee: BIOWISDOM LTD., Cambridge (GB)

(21) Appl. No.: 12/096,578

(22) PCT Filed: Dec. 8, 2006
(86) PCT No.: PCT/GB2006/004596

§ 371 Date: Nov. 20, 2008

(30) Foreign Application Priority Data
Dec. 8, 2005 (GB) 0525049.3

(51) Int. Cl. G01N 21/59

(52) U.S. Cl. 435/7.94

(57) ABSTRACT

The present invention relates to a method of detecting skeletal muscle damage and to the use of certain proteins and fragments thereof as biological markers (commonly known as “biomarkers”) for such damage. The present invention has particular reference to the detection of muscle toxicity in mammals, particularly humans.

The present invention relates to a method of detecting skeletal muscle damage and to the use of certain proteins and fragments thereof as biological markers (commonly known as “biomarkers”) for such damage. The present invention has particular reference to the detection of muscle toxicity in mammals, particularly humans.

Muscle toxicity is an undesirable side-effect of the administration of some medicinal or veterinary products to some human or animal patients. Whether or not a given product causes toxicity depends upon factors such as the properties of the product itself and on the susceptibility of the patient to such toxicity. Some patients may be genetically predisposed to produce an adverse toxic reaction to certain products.

A toxic or other insult to mammalian tissue may provoke a variety of different cellular responses that are characteristic of stress to the tissue. The nature of such responses may depend upon the severity or duration of the insult, but may ultimately result in damage to the tissue giving rise to symptoms that in some cases may be chronic. Accordingly it is desirable to test new products for such toxicity.

In particular it is desirable to test new products for muscle toxicity and to be able to diagnose skeletal muscle damage in patients.

Biomarkers are commonly used to measure the progress of a disease or other condition. Biomarkers can range from imaging readouts to proteins that can be measured specifically in accessible body fluids such as blood, serum and urine. The identification of protein biomarkers is popular because of ease and cost of measurement, and there are a number of well-established protein biomarkers available such, for example, as prostate specific antigen (PSA) for prostate cancer.

Certain troponin isoforms have been proposed as biomarkers for drug-induced cardiac muscle injury. Myosin heavy polypeptides have also been proposed for use as biomarkers for cardiac muscle toxicity.

Developing biomarkers for a specific disease or pathology is challenging because any useful biomarker should be specific for that condition, sensitive enough to detect early forms of the disease or pathology, measurable in body fluids that can be readily sampled (often several times in any one subject) and should have a strong signal-to-noise ratio.

Biomarkers for skeletal muscle damage should be specific for skeletal muscle damage and should not normally be associated with damage to other tissue types, particularly heart muscle, liver or kidney tissue which are known to be susceptible to toxic insult.

An object of the present invention is to provide biomarkers for detecting or monitoring skeletal muscle damage in mammals, particularly humans or non-human animals (e.g. experimental animals such as mice, rats and the like).

A particular object of the present invention is to provide biomarkers for detecting early stage muscle stress.

Another object of the invention is to provide improved biomarkers for skeletal muscle damage that meet the requirements of specificity, sensitivity and measurability.

A different object of the present invention is to provide a method for detecting skeletal muscle damage in mammals, particularly humans or non-human animals.

Yet another object of the present invention is to provide a method for diagnosing muscle toxicity in mammals, particularly humans or non-human animals.

Yet another object of the present invention comprehends the use of known proteins and splice variants or fragments thereof as biomarkers for skeletal muscle damage.

Yet another object of the present invention is to provide a method for investigating the potential skeletal muscle toxicity of a medicinal or veterinary product for administration to the mammalian body, particularly in humans or non-human animals.

According to one aspect of the present invention therefore there is provided the use of a protein, or a splice variant or fragment of said protein, that is:
(i) expressed in skeletal muscle tissue, but is absent or expressed to a lesser extent in heart, liver or kidney tissue;
(ii) associated with muscle-specific functions or expressed or upregulated when such muscle tissue is stressed; and
(iii) located in the cytoplasm of skeletal muscle cells; as a biomarker for muscle damage in a mammal.

According to another aspect of the present invention there is provided a method of detecting skeletal muscle damage, said method comprising assaying a sample of body fluid obtained from a mammal for one or more protein biomarkers, which protein biomarkers are selected from proteins that are:
(i) expressed in skeletal muscle tissue, but are absent or expressed to a lesser extent in heart, liver or kidney tissue;
(ii) associated with muscle-specific functions, or are expressed or upregulated when such muscle tissue is stressed; and
(iii) located in the cytoplasm of skeletal muscle cells; or from splice variants and fragments of such proteins.

Said mammal may comprise a human or a non-human animal, preferably a human.

Said method may be conducted entirely ex vivo. Said body fluid may comprise blood, plasma, serum or urine. Preferably said body fluid is serum or plasma obtained from a blood sample.

All proteins expressed in skeletal muscle have potential use as biomarkers for muscle damage or toxicity. Over three thousand different mRNAs are expressed in human skeletal muscle, but many of them are also normally co-expressed in other tissues that are known to be susceptible to drug-induced toxicity and are therefore not specific for skeletal muscle damage. For instance, many such mRNAs are expressed in heart, liver and kidney tissues which are known to be particularly prone to toxic insult. Further, proteins that are normally resident in blood would have limited use as biomarkers as their presence in a detection medium under normal physiological conditions could mask any elevation following tissue damage, resulting in a poor signal-to-noise ratio. Accordingly, the present invention comprehends the use as a biomarker of a protein that is expressed in skeletal muscle tissue but is normally absent, or expressed to a lesser extent, under normal physiological conditions (i.e. in the absence of disease) in whole blood or other tissues, including particularly heart, liver and kidney tissues.

By “expressed to a lesser extent” is meant herein that the levels of mRNA for said biomarker found in heart, liver and kidney tissues are significantly lower than in skeletal muscle tissue.

Preferably the biomarkers according to the present invention are expressed in skeletal muscle tissue, but are absent or expressed to a lesser extent in heart, liver or kidney tissue under normal conditions or when such tissues are subjected to a toxic insult.

Said one or more proteins selected in accordance with the present invention for use as biomarkers of skeletal muscle damage are also associated with muscle-specific functions or cellular stress. Typical muscle-specific functions include myoblast differentiation, myoblast cell fate determination, muscle development, muscle contraction, sarcomere alignment, myoblast fusion, actin filament based movement, muscle cell differentiation, somatic muscle development, myogenesis, neuromuscular junction development striated and muscle contraction.

Further, soluble proteins are more likely to be released from the cell upon lysis than those that are membrane bound. Those that can be secreted from the cell prior to lysis might be expected to show even more sensitivity. According to the present invention, therefore, said protein biomarkers are located within the cytoplasmic or soluble fraction of the cell or contain a signal sequence that targets the protein for secretion For example, the proteins may be components of the cytoskeleton.

In some embodiments of the invention, said one or more protein biomarkers may be selected from mitogen-activated protein kinase 12 (MAPK12), rho GTPase activating protein 26 (ARHGAP26), lactoperoxidase (LPO), acrosin (ACR), cathepsin E (CTSE), four and a half LIM domains 3 (FHL3), kelch repeat and BTB (POZ) domain containing 10 (KBTBD10), Fanconi anemia complementation group A (FANCA) and myosin binding protein H (MYBPH).

Preferably said protein biomarkers are selected from the human forms of the above-mentioned proteins.

In some embodiments said one or more protein biomarkers may comprise mitogen-activated protein kinase 12 (MAPK12). Preferably, said MAPK12 protein comprises the amino acid sequence of SEQ ID NO. 1.

In some embodiments said one or more protein biomarkers may comprise rho GTPase activating protein 26 (ARHGAP26). Preferably, said ARHGAP26 protein comprises the amino acid sequence of SEQ ID NO. 2. Alternatively, said ARHGAP26 protein may comprise the isoform amino acid sequence of SEQ ID NO. 10 which is a fragment SEQ ID NO. 2.

In some embodiments said one or more protein biomarkers may comprise lactoperoxidase (LPO). Preferably, said LPO protein comprises the amino acid sequence of SEQ ID NO. 3.

In some embodiments said one or more protein biomarkers may comprise acrosin (ACR). Preferably, said ACR protein comprises the amino acid sequence of SEQ ID NO. 4.

In some embodiments said one or more protein biomarkers may comprise cathepsin E (CTSE). Preferably, said CTSE protein comprises the amino acid sequence of SEQ ID NO. 5.

In some embodiments said one or more protein biomarkers may comprise four and a half LIM domains 3 (FHL3). Preferably, said FHL3 protein comprises the amino acid sequence of SEQ ID NO. 6.

In some embodiments said one or more protein biomarkers may comprise kelch repeat and BTB (POZ) domain containing 10 (KBTBD10). Preferably, said KBTBD10 protein comprises the amino acid sequence of SEQ ID NO. 7.

In some embodiments said one or more protein biomarkers may comprise Fanconi anemia complementation group A (FANCA). Preferably, said FANCA protein comprises the amino acid sequence of SEQ ID NO. 8.

In some embodiments said one or more protein biomarkers may comprise myosin binding protein H (MYBPH). Preferably, said MYBPH protein comprises the amino acid sequence of SEQ ID NO. 9.

Each of the above-mentioned proteins may exist in a number of different respective variants in which one or more amino acids are deleted, substituted or inserted. The present invention comprehends the use of any of such variants which cross-react immunogenically.

Accordingly, in some embodiments, said one or more protein biomarkers may be selected from poly- or oligo-peptides comprising or consisting essentially of:

(i) a polypeptide of any one of SEQ ID NOS. 1 to 9;

(ii) a polypeptide having at least 80% identity to any one of the polypeptides of SEQ ID NOS. 1 to 9;

(iii) a polypeptide of any one of SEQ ID NOS. 1 to 9 having one or a few amino acid deletions, substitutions or insertions; or

(iv) fragments of at least five contiguous amino acids of said polypeptides (i), (ii) or (iii), which fragments are capable of binding to antibodies that bind specifically to said respective polypeptides.

By “identity” is meant herein the extent to which two polypeptides are invariant. Where the two polypeptides are non-identical, then they should be aligned for maximal correspondence in accordance with a computer algorithm known in the art for such purpose. For instance, two polypeptide sequences may be compared using the BLAST 2 program [13]. Two popular multiple sequence alignment algorithms for polypeptides are ClustalW [14] and T-Coffee [15].

Preferably said polypeptide (ii) has at least 90%, and more preferably at least 95%, identity with any one of polypeptides of SEQ ID NOS. 1 to 10. For instance, said polypeptide (ii) may have at least 96%, 97%, 98% or 99% identity with said any one of polypeptides of SEQ ID NOS. 1 to 10.

Preferably, said fragments comprise at least ten, and more preferably at least fifteen, contiguous amino acids of (i), (ii) or (iii).

By “fragments” of said proteins is meant polypeptides that comprise fewer amino acids than the corresponding full-length protein, including splice-variants. Antibodies cross-reacting with said variants also have specificity for the corresponding full-length proteins. Said fragments and variants may therefore share one or more epitopes with the full-length protein and would not normally comprehend portions of said full-length proteins that are not distinctive or characteristic of the proteins such, for example, as some transmembrane portions that are highly conserved amongst many membrane-bound proteins. The amino acid sequence of SEQ ID NO. 10 is an exemplary fragment of the amino acid sequence of SEQ ID NO. 2.

Proteins that are upregulated in response to a toxic or other insult to the tissue may provide biomarkers with high sensitivity, especially during the early stages. At very low levels of stress the effects can be mitogenic, inducing cell growth and proliferation. As the challenge increases, tissues enter a phase of growth arrest and repair and, ultimately, undergo cell death by apoptosis or necrosis.

Accordingly, in some embodiments, the present invention comprehends the use as a biomarker of skeletal muscle damage of a protein associated with one or more early stage stress functions, such, for example, as mitosis, cell proliferation, cell growth, hyperplasia, intracellular signalling cascade and signal transduction pathway.

Said biomarker may therefore be selected from mitogen-activated protein kinase 12 and rho GTPase activating protein 26.

By targeting early stage stress, one can identify biological markers of early and perhaps reversible toxicity-induced stress.

In some embodiments, the present invention comprehends the use as a biomarker of skeletal muscle damage of a protein associated with one or more intermediate phase stress functions, such, for example, as DNA Repair, response to stress, oxidative stress response, cell ageing, JAK-STAT cascade, double-strand break repair and oxidation.

Said biomarker may therefore be selected from Fanconi anemia, complementation Group A and lactoperoxidase. The use of lactoperoxidase may be especially advantageous, since this protein possesses a predicted signal peptide and is therefore probably secreted.

Further, in some embodiments, the present invention comprehends the use as a biomarker of skeletal muscle damage of a protein associated with one or or more late phase stress functions, such, for example, as peptidolysis, proteolysis, endocytosis, digestion, apoptosis, ATP-dependent proteolysis, inflammatory response, cell death, response to wounding, cell cycle arrest, necrosis and inflammation.

Said biomarker may therefore be selected from acrosin, cathepsin E, mitogen-activated protein kinase 12. Like lactoperoxidase, acrosin possesses a predicted signal peptide and may therefore be secreted, making it especially suitable for use as a biomarker according to the present invention.

Said protein biomarkers may be qualitatively or quantitatively assayed using any suitable method known to those skilled in the art such, for example, as an enzyme-linked immunosorbent assays (ELISA) or Western blotting, both of which make use of antibodies to the protein biomarkers. Preferably, sandwich ELISA may be used. Such antibodies may be monoclonal or polyclonal antibodies, and methods of obtaining such antibodies are also well-known in the art.

In a particular aspect of the present invention, said sample of body fluid may be obtained from said patient following administration of a medicinal product to said patient. The method of the present invention may therefore be used to investigate the toxicology of said medicinal product. Said assay may be carried out on a serum sample, whole blood or plasma obtained from a blood sample.

In some embodiments, a series of samples taken periodically from said patient may be assayed to monitor the toxicity of a medicinal or veterinary product over time.

In some embodiments, said sample or samples may be assayed for only one protein biomarker.

Alternatively, said sample or samples may be tested for a plurality of protein biomarkers. Assaying a series of samples obtained over time for a panel of biomarkers may be advantageous where one biomarker is expressed at an earlier stage during the progression of a toxic response than another biomarker. The results of such assays may therefore be used to indicate the extent of progression of said toxic response.

Assaying for two or more biomarkers may also serve to reduce the risk of misdiagnosis.

Accordingly, in yet another aspect of the present invention there is provided a method of diagnosing muscle toxicity in a mammalian patient which comprises obtaining a sample of body fluid from said patient and assaying said sample for at least one protein biomarker selected from proteins that are:
(i) normally expressed in skeletal muscle tissue, but are absent or expressed to a lesser extent in heart, liver or kidney tissue;
(ii) associated with muscle-specific functions or expressed or upregulated when such muscle tissue is stressed; and
(iii) located in the cytoplasm of skeletal muscle cells; or from splice variants and fragments of such proteins.

As described above, said method may comprise assaying said sample for two or more of such protein biomarkers.

In yet another aspect of the present invention there is provided a method for investigating the toxicology of a candidate medicinal or veterinary product in mammalian patients, which method comprises administering said candidate product to one or more patients, obtaining a sample of body fluid from the or each patient and assaying said sample for at least one protein biomarker selected from proteins, or splice variants or fragments of said proteins, that are:
(i) normally expressed in skeletal muscle tissue, but are absent or expressed to a lesser extent in heart, liver or kidney tissue;
(ii) associated with muscle-specific functions or expressed or upregulated when such muscle tissue is stressed; and
(iii) located in the cytoplasm of skeletal muscle cells.

Said method may comprise assaying said sample for two or more such protein biomarkers.

Said method may further comprise periodically obtaining samples from the or each patient to provide a series of samples over time and assaying each of said samples for one or more of said protein biomarkers.

Preferably, said candidate medicinal or veterinary product is not insulin or medication presently prescribed for diabetes.

Preferably, skeletal muscle damage does not refer to age-related changes in skeletal muscle, or to changes in patients with diabetes, in particular type 2 diabetes, or to changes in skeletal muscle associated with cancer.

Following is a description by way of example only of embodiments of the present invention.

### EXAMPLE 1

Mitogen-activated protein kinase 12 (MAPK12) is located in skeletal muscle [1]. It is also known that MAPK12 is a cytoplasmic protein that is involved in myoblast differentiation, cell cycle arrest, signal transduction, muscle development and the cell cycle process [2]. Accordingly, MAPK12 is selected as a protein biomarker for skeletal muscle damage in accordance with the present invention. MAPK12 may be a biomarker for early and late stage skeletal muscle stress.

A candidate drug X is administered daily in a prescribed dosage amount to a plurality, e.g. twenty to one hundred, of healthy human volunteers or experimental non-human animals.

### Preparation of Plasma Samples

Periodically a blood sample is taken from each volunteer. In this example, the samples are taken daily at a predetermined time, but in other embodiments, the samples may be taken more or less frequently. The blood samples are collected into an anticoagulant solution, e.g. 3.8% trisodium citrate in the proportion of 9 volumes of blood to 1 volume of anticoagulant solution. The two components are gently mixed and centrifuged at 3,000 rpm for 10 minutes. The supernatant (plasma) is carefully removed without disturbing the pellet of red cells.

The following protocol assumes that the biomarkers of muscle damage will reach sufficient concentrations through tissue leakage to allow quantitation by sandwich ELISA without additional sample preparation. Should concentration of the plasma sample be necessary prior to analysis, this can be achieved by a variety of methods, such as vacuum evaporation, ultrafiltration or TCA precipitation.

### Sandwich ELISA Protocol

A 96 well microtitre plate is pre-coated with 50 μl of a 10 μg/ml solution of unlabelled antibody and incubated at 37° C. for 1 hour or overnight at 4° C. Anti-MAPK12 antibodies are available commercially, for example from Abgent [3]. The plate is washed twice in phosphate buffered saline (PBS) to remove unbound antibody then incubated for 1 hour at 37° C. in blocking buffer, a solution of PBS containing 1% bovine serum albumin (BSA), to saturate any non-specific binding sites.

An antigen standard is serially diluted in blocking buffer, to prepare a standard curve comprising at least five points in the range of 50-150% of the expected concentration of antigen in plasma. Samples are diluted, if required, in blocking buffer and a negative control sample (a human plasma that tests negative for the antigen under consideration) is treated in the same way as the samples. Diluted samples and standards are added at each concentration in at least duplicate (˜50 μl per well) and incubated for 1 hour at 37° C.

After washing four times in PBS, 50 μl of biotin-labelled antibody, diluted in blocking buffer according to the manufacturer's recommendations, is added to each well and incubated for 1 hour at 37° C. The PBS washing step is repeated before adding 50 μl of horseradish peroxidase (HRP)-streptavidin (diluted in blocking buffer according to manufacturer's recommendations) and further incubating at 37° C. for 60 minutes.

After repeating the washing step, 200 μl of substrate is added to each well. A suitable substrate is ABTS (2,2′-azino-di-(3-ethylbenz-thiazoline sulfonic acid)). The plate is incubated at room temperature until the colour has developed sufficiently, typically between 2 and 20 minutes. The absorbance at 414 nm is measured using an ELISA plate reader, blanking against the negative control sample. The concentration of antigen present in the sample is determined by selecting one or more sample concentrations that fall within the linear portion of the standard curve, and correcting for the dilution performed prior to analysis.

The presence of MAPK12 in any plasma sample is indicative of skeletal muscle damage, possibly resulting from toxicity produced by the administration of drug X.

### EXAMPLE 2

Rho GTPase activating protein 26 (ARHGAP26) is known to be located in skeletal muscle [4] and to be involved in actin filament biogenesis [2]. Accordingly, ARHGAP26 is selected as a protein biomarker for skeletal muscle damage in accordance with the present invention. Example 1 is repeated using goat anti-ARHGAP26 polyclonal antibodies which are commercially available from, for example, IMGENEX [5].

### EXAMPLE 3

Lactoperoxidase (LPO) is known to be located in skeletal muscle [1] and to be involved in the response to oxidative stress [2]. The precursor form of the protein possesses a potential signal peptide and is therefore likely to be secreted [6]. Accordingly, LPO is selected as a protein biomarker for skeletal muscle damage in accordance with the present invention. Example 1 is repeated using sheep anti-bovine LPO polyclonal antibodies, which are commercially available, for example, from Research Diagnostics, Inc. [7]. This antibody had been raised against the bovine LPO orthologue; the literature suggests that human salivary peroxidase and bovine lactoperoxidase are cross-reactive [8].

### EXAMPLE 4

Acrosin (ACR) is known to be located in skeletal muscle [1] and to be involved in proteolysis [2]. The precursor form of the protein possesses a potential signal peptide and is therefore likely to be secreted [6]. Accordingly, ACR is selected as a protein biomarker for skeletal muscle damage in accordance with the present invention. Example 1 is repeated using, for example, two from a panel of anti-acrosin monoclonal antibodies that can be purchased from Biosonda [9].

### EXAMPLE 5

Cathepsin E (CTSE) is known to be located in skeletal muscle [1] and to be involved in digestion and proteolysis [2]. Accordingly, CTSE is selected as a protein biomarker for skeletal muscle damage in accordance with the present invention. Example 1 is repeated using an anti-cathepsin E antibody, for example goat anti-human cathepsin E available from R&D Systems [10].

### EXAMPLE 6

Four and a half LIM domains 3 (FHL3) is known to be located in skeletal muscle [1] and to be involved in muscle development [2]. Accordingly, FHL3 is selected as a protein biomarker for skeletal muscle damage in accordance with the present invention. Example 1 is repeated using a suitable antibody, e.g. chicken anti-FHL3 polyclonal antibody, which is available from Abeam [11].

### EXAMPLE 7

Fanconi anemia complementation group A (FANCA) is known to be located in skeletal muscle [1] and to be involved in DNA repair [2]. Accordingly, FANCA is selected as a protein biomarker for skeletal muscle damage in accordance with the present invention. Example 1 is repeated using an appropriate antibody, for example rabbit anti-human FANCA antibody, which can be obtained from Abeam [11].

### EXAMPLE 8

Myosin binding protein H (MYBPH) is known to be located in skeletal muscle [1] and to be involved in muscle development [2]. Accordingly, MYBPH is selected as a protein biomarker for skeletal muscle damage in accordance with the present invention. Example 1 is repeated using an appropriate anti-MYBPH antibody; generation of a site-directed polyclonal antibody to MYBPH is described in the literature [12].

### EXAMPLE 9

Kelch repeat and BTB (POZ) domain containing 10 (KBTBD10) is known to be located in skeletal muscle [4] and to be involved in striated muscle contraction [2]. Accordingly, KBTBD10 is selected as a protein biomarker for skeletal muscle damage in accordance with the present invention. Example 1 is repeated using a polyclonal anti-human KBTBD10 antibody; such a product does not currently exist commercially, so antibodies should be raised against human KBTBD10 protein.

### EXAMPLE 10

Example 1 is repeated using a panel of protein biomarkers, said panel including at least one protein that is associated with one or more early stage stress functions as described above, at least one that is associated with one or more intermediate phase stress functions and at least one that is associated with one or or more late stage functions, e.g. Rho OTPase activating protein 26 (early), Fanconi anemia complementation group A (intermediate) and Cathepsin E (late). This combination of biomarkers is used to monitor progress of damage to the muscle.

### REFERENCES

The contents of the following references are all incorporated severally herein by reference.
1. Haverty et al., Nucleic Acids Res. 2002 Jan. 1; 30(1):214-7
2. Maglott et al., Nucleic Acids Res. 2005 Jan. 1; 33(Database issue):D54-8
3. MAPK12 antibodies: http://www.abgent.com/
4. Wheeler et al., Nucleic Acids Res. 2005 Jan. 1; 33(Database issue):D39-45
5. ARHGAP26 antibodies: http://www.imgenex.com/
6. Bairoch et al., Nucleic Acids Res. 2005 Jan. 1; 33(Database issue):D154-9
7. LPO antibodies: http://www.researchd.com/
8. Mansson-Rahemtulla et al., J Dent Res. 1990 December; 69(12):1839-46
9. ACR antibodies: http://www.biosonda.com
10. CTSE antibodies: http://www.rndsystems.com/
11. FHL3 and FANCA antibodies: http://www.abcam.com/
12. Alyonycheva et al., Circ Res. 1997 May; 80(5):665-72
13. Tatiana et al., FEMS Microbiol Lett. 174:247-250
14. Thompson et al., Nucleic Acids Res. 1994 Nov. 11; 22(22):4673-80
15. Notredame et al., J Mol. Biol. 2000 Sep. 8; 302(1):205-17

1. A method of detecting skeletal muscle damage, said method comprising assaying a sample of body fluid obtained from a mammal for one or more protein biomarkers, which protein biomarkers are selected from proteins, or splice variants or fragments of said proteins, that are:
(i) expressed in skeletal muscle tissue, but are absent or expressed to a lesser extent in heart, liver or kidney tissue;
(ii) associated with muscle-specific functions or expressed or upregulated when such muscle tissue is stressed; and
(iii) located in the cytoplasm of skeletal muscle cells.

2. A method as claimed in claim 1, wherein said sample is taken from said mammal following administration of a medicinal product to said mammal.

3. A method as claimed in claim 1 or claim 2, characterised by testing a series of samples taken periodically from said mammal.

4. A method as claimed in claim 1, claim 2 or claim 3, characterised by testing said sample or samples for only one protein biomarker.

5. A method as claimed in claim 1, claim 2 or claim 3, characterised by testing said sample or samples for a plurality of protein biomarkers.

6. A method as claimed in claim 5, characterised in that one of said biomarkers is expressed at an earlier stage of muscle damage than another of said biomarkers.

7. A method as claimed in claim 6, characterised in that at least one of the proteins is associated with one or more early or intermediate stage stress functions and at least one is associated with one or more intermediate or late phase stress functions.

8. A method as claimed in any preceding claim, wherein said body fluid is plasma, serum or urine.

9. A method of diagnosing muscle toxicity in a mammal which comprises obtaining a sample of body fluid from said mammal and assaying said sample for at least one protein biomarker selected from proteins, or splice variants or fragments of said proteins, that are:
(i) normally expressed in skeletal muscle tissue, but are absent or expressed to a lesser extent in heart, liver or kidney tissue;
(ii) associated with muscle-specific functions or are expressed or upregulated when such muscle tissue is stressed; and
(iii) located in the cytoplasm of skeletal muscle cells.

10. A method as claimed in claim 9, further comprising assaying said sample for two or more of such protein biomarkers.

11. A method as claimed in claim 10, characterised in that one of said biomarkers is expressed at an earlier stage during the progression of a toxic response than another of said biomarkers.

12. A method as claimed in claim 11, characterised in that at least one of the proteins is associated with one or more early or intermediate stage stress functions and at least one is associated with one or more intermediate or late phase stress functions.

13. A method for investigating the toxicology of a candidate medicinal or veterinary product in mammals, which method comprises administering said candidate product to one or more mammals, obtaining a sample of body fluid from the or each mammal and assaying said sample for at least one protein biomarker selected from proteins, or splice variants or fragments of said proteins, that are:
(i) normally expressed in skeletal muscle tissue, but are absent or expressed to a lesser extent in heart, liver or kidney tissue;
(ii) associated with muscle-specific functions or are expressed or upregulated when such muscle tissue is stressed; and
(iii) located in the cytoplasm of skeletal muscle cells.

14. A method as claimed in claim 13, further comprising assaying said sample for two or more such protein biomarkers.

15. A method as claimed in claim 14, characterised in that one of said biomarkers is expressed at an earlier stage during the progression of a toxic response than another of said biomarkers.

16. A method as claimed in claim 15, characterised in that at least one of the proteins is associated with one or more early or intermediate stage stress functions and at least one is associated with one or more intermediate or late phase stress functions.

17. A method as claimed in claim 14, claim 15 or claim 16, further comprising periodically obtaining samples from the or each mammal to provide a series of samples over time and assaying each of said samples for one or more of said protein biomarkers.


SEQUENCE LISTING (10 sequences)

SEQ ID NO: 1 - protein, 367 aa, Homo sapiens
MSSPPPARSGFYRQEVTKTAWEVRAVYRDLQPVGSGAYGAVCSAVDGRTGAKVAIKKLYRPFQSELFAKRAYRELRLLKHMRHENVIGLLDVFTPDETLDDFTDFYLVMPFMGTDLGKLMKHEKLGEDRIQFLVYQMLKGLRYIHAAGIIHRDLKPGNLAVNEDCELKILDFGLARQADSEMTGYVVTRWYRAPEVILNWMRYTQTVDIWSVGCIMAEMITGKTLFKGSDHLDQLKEIMKVTGTPPAEFVQRLQSDEAKNYMKGLPELEKKDFASILTNASPLAVNLLEKMLVLDAEQRVTAGEALAHPYFESLHDTEDEPQVQKYDDSFDDVDRTLDEWKRVTYKEVLSFKPPRQLGARVSKETPL

SEQ ID NO: 2 - protein, 814 aa, Homo sapiens
MGLPALEFSDCCLDSPHFRETLKSHEAELDKTNKFIKELIKDGKSLISALKNLSSAKRKFADSLNEFKFQCIGDAETDDEMCIARSLQEFATVLRNLEDERIRMIENASEVLITPLEKFRKEQIGAAKEAKKKYDKETEKYCGILEKHLNLSSKKKESQLQEADSQVDLVRQHFYEVSLEYVFKVQEVQERKMFEFVEPLLAFLQGLFTFYHHGYELAKDFGDFKTQLTISIQNTRNRFEGTRSEVESLMKKMKENPLEHKTISPYTMEGYLYVQEKRHFGTSWVKHYCTYQRDSKQITMVPFDQKSGGKGGEDESVILKSCTRRKTDSIEKRFCFDVEAVDRPGVITMQALSEEDRRLWMEAMDGREPVYNSNKDSQSEGTAQLDSIGFSIIRKCIHAVETRGINEQGLYRIVGVNSRVQKLLSVLMDPKTASETETDICAEWEIKTITSALKTYLRMLPGPLMMYQFQRSFIKAAKLENQESRVSEIHSLVHRLPEKNRQMLQLLMNHLANVANNHKQNLMTVANLGVVFGPTLLRPQEETVAAIMDIKFQNIVIEILIENHEKIFNTVPDMPLTNAQLHLSRKKSSDSKPPSCSERPLTLFHTVQSTEKQEQRNSIINSSLESVSSNPNSILNSSSSLQPNMNSSDPDLAVVKPTRPNSLPPNPSPTSPLSPSWPMFSAPSSPMPTSSTSSDSSPVRSVAGFVWFSVAAVVLSLARSSLHAVFSLLVNFVPCHPNLHLLFDRPEEAVHEDSSTPFRKAKALYACKAEHDSELSFTAGTVFDNVHPSQEPGWLEGTLNGKTGLIPENYVEFL

SEQ ID NO: 3 - protein, 712 aa, Homo sapiens
MRVLLHLPALLASLILLQAAASTTRAQTTRTSAISDTVSQAKVQVNKAFLDSRTRLKTAMSSETPTSRQLSEYLKHAKGRTRTAIRNGQVWEESLKRLRQKASLTNVTDPSLDLTSLSLEVGCGAPAPVVRCDPCSPYRTITGDCNNRRKPALGAANRALARWLPAEYEDGLSLPFGWTPGKTRNGFPLPLAREVSNKIVGYLNEEGVLDQNRSLLFMQWGQIVDHDLDFAPDTELGSSEYSKAQCDEYCIQGDNCFPIMFPPNDPKAGTQGKCMPFFRAGFVCPTPPYKSLAREQINALTSFLDASFVYSSEPSLASRLRNLSSPLGLMAVNQEVSDHGLPYLPYDSKKPSPCEFINTTARVPCFLAGDSRASEHILLATSHTLFLREHNRLARELKRLNPQWDGEKLYQEARKILGAFVQIITFRDYLPILLGDHMQKWIPPYQGYSESVDPRISNVFTFAFRFGHLEVPSSMFRLDENYQPWGPEPELPLHTLFFNTWRMVKDGGIDPLVRGLLAKKSKLMKQNKMMTGELRNKLFQPTHRIHGFDLAAINTQRCRDHGQPGYNSWRAFCDLSQPQTLEELNTVLKSKMLAKKLLGLYGTPDNIDIWIGAIAEPLVERGRVGPLLACLLGKQFQQIRDGDRFWWENPGVFTNEQKDSLQKMSFSRLVCDNTRITKVPRDPFWANSYPYDFVDCSAIDKLDLSPWASVKN

SEQ ID NO: 4 - protein, 421 aa, Homo sapiens
MVEMLPTAILLVLAVSVVAKDNATCDGPCGLRFRQNPQGGVRIVGGKAAQHGAWPWMVSLQIFTYNSHRYHTCGGSLLNSRWVLTAAHCFVGKNNVHDWRLVFGAKEITYGNNKPVKAPLQERYVEKIIIHEKYNSATEGNDIALVEITPPISCGRFIGPGCLPHFKAGLPRGSQSCWVAGWGYIEEKAPRPSSILMEARVDLIDLDLCNSTQWYNGRVQPTNVCAGYPVGKIDTCQGDSGGPLMCKDSKESAYVVVGITSWGVGCARAKRPGIYTATWPYLNWIASKIGSNALRMIQSATPPPPTTRPPPIRPPFSHPISAHLPWYFQPPPRPLPPRPPAAQPPPPPSPPPPPPPPASPLPPPPPPPPPTPSSTTKLPQGLSFAKRLQQLIEVLKGKTYSDGKNHYDMETTELPELTSTS

SEQ ID NO: 5 - protein, 401 aa, Homo sapiens
MKTLLLLLLVLLELGEAQGSLHRVPLRRHPSLKKKLRARSQLSEFWKSHNLDMIQFTESCSMDQSAKEPLINYLDMEYFGTISIGSPPQNFTVIFDTGSSNLWVPSVYCTSPACKTHSRFQPSQSSTYSQPGQSFSIQYGTGSLSGIIGADQVSAFATQVEGLTVVGQQFGESVTEPGQTFVDAEFDGILGLGYPSLAVGGVTPVFDNMMAQNLVDLPMFSVYMSSNPEGGAGSELIFGGYDHSHFSGSLNWVPVTKQAYWQIALDNIQVGGTVMFCSEGCQAIVDTGTSLITGPSDKIKQLQNAIGAAPVDGEYAVECANLNVMPDVTFTINGVPYTLSPTAYTLLDFVDGMQFCSSGFQGLDIHPPAGPLWILGDVFIRQFYSVFDRGNNRVGLAPAVP

SEQ ID NO: 6 - protein, 280 aa, Homo sapiens
MSESFDCAKCNESLYGRKYIQTDSGPYCVPCYDNTFANTCAECQQLIGHDSRELFYEDRHFHEGCFRCCRCQRSLADEPFTRQDSELLCNDCYCSAFSSQCSACGETVMPGSRKLEYGGQTWHEHCFLCIGCEQPLGSRPFVPDKGAHYCVPCYENNFAPRCARCTKTLTQGGLTYRDLPWHPKCLVCTGCQTPLAGQQFTSRDEDPYCVACFGELFAPKCSSCKRPIVGLGGGKYVSFEDRHWHHNCFTCDRCSNSLVGQGFVPDGDQVLCQGCSQAGP

SEQ ID NO: 7 - protein, 606 aa, Homo sapiens
MDSQRELAEELRLYQSTLLQDGLKDLLDEKKFIDCTLKAGDKSLPCHRLILSACSPYFREYFLSEIDEAKKKEVVLDNVDPAILDLIIKYLYSASIDLNDGNVQDIFALASRFQIPSVFTVCVSYLQKRLAPGNCLAILRLGLLLDCPRLAISAREFVSDRFVQICKEEDFMQLSPQELISVISNDSLNVEKEEAVFEAVMKWVRTDKENRVKNLSEVFDCIRFRLMTEKYFKDHVEKDDIIKSNPDLQKKIKVLKDAFAGKLPEPSKNAAKTGAGEVNGDVGDEDLLPGYLNDIPRHGMFVKDLILLVNDTAAVAYDPTENECYLTALAEQIPRNHSSIVTQQNQIYVVGGLYVDEENKDQPLQSYFFQLDSIASEWVGLPPLPSARCLFGLGEVDDKIYVVAGKDLQTEASLDSVLCYDPVAAKWNEVKKLPIKVYGHNVISHKGMIYCLGGKTDDKKCTNRVFIFNPKKGDWKDLAPMKIPRSMFGVAVHKGKIVIAGGVTEDGLSASVEAFDLTTNKWDVMTEFPQERSSISLVSLAGSLYAIGGFAMIQLESKEFAPTEVNDIWKYEDDKKEWAGMLKEIRYASGASCLATRLNLFKLSKL

SEQ ID NO: 8 - protein, 1455 aa, Homo sapiens [sequence omitted]

SEQ ID NO: 9 - protein, 477 aa, Homo sapiens
MMEKNTSEGPACSPEETASESAKVPTAEPPGEVAVSESTREEQVPKPHGPAPQAPTASTATKPAPPSEDVPSAPLLLTLDDVSSSSVTVSWEPPERLGRLGLQGYVLELCREGASEWVPVSARPMMVTQQTVRNLALGDKFLLRVSAVSSAGAGPPAMLDQPIHIRENIEAPKIRVPRHLRQTYIRQVGETVNLQIPFQGKPKPQATWTHNGHALDSQRVSMRTGDQDSILFIRSAQRSDSGRYELTVRVEDLEAKAVIDILVIEKPGPPSSIRLLDVWGCNAALQWTPPQDTGNTELLGYMVQKADKKTGQWFTVLERYHPTTCTISDLIIGNSYSFRVFSENLCGLSTSATVTKELAHIQKADIAAKPKGFIERDFSEAPSFTQPLADHTSTPGYSTQLFCSVRASPKPKIIWMKNKMEIQGNPKYRALSEQGVCTLEIRKPSPFDSGVYTCKAINVLGEASVDCRLEVKASAAH

SEQ ID NO: 10 - protein, 759 aa, Homo sapiens [sequence omitted]